(19) United States
(12) Patent Application Publication
(10) Pub. No.: US 2022/0286969 A1
(43) Pub. Date: Sep. 8, 2022

(54) INFORMATION PROCESSING APPARATUS AND CONTROL METHOD

(71) Applicant: Lenovo (Singapore) Pte. Ltd., Singapore (SG)

(72) Inventors: Hiroki Oda, Kanagawa (JP); Kazuhiro Kosugi, Kanagawa (JP)

(73) Assignee: Lenovo (Singapore) Pte. Ltd., Singapore (SG)

(21) Appl. No.: 17/327,083

(22) Filed: May 21, 2021

(30) Foreign Application Priority Data
Mar. 8, 2021 (JP) 2021-036003

(51) Int. Cl. H04W 52/02

(52) U.S. Cl. CPC H04W 52/0274

(57) ABSTRACT

An information processing apparatus includes a wireless communication module configured to perform wireless communication and a module control unit configured to enable operation of the wireless communication module in response to receiving an enable request for the wireless communication module, the enable request being output to the module control unit when a power reduction function that limits output power of radio waves output by the wireless communication module is enabled, and disable the operation of the wireless communication module in response to receiving a disable request for the wireless communication module, the disable request being output to the module control unit when the power reduction function is disabled.

### CROSS REFERENCE TO RELATED APPLICATIONS

The present application is based on and claims priority from Japanese Patent Application No. 2021-036003 filed on Mar. 8, 2021, the entire contents of which are incorporated herein by reference.

### TECHNICAL FIELD

The present disclosure relates to an information processing apparatus and a control method.

### BACKGROUND

In recent years, information processing apparatuses such as laptop personal computers (laptop PCs) each including a wireless communication module such as a WANN module connectable to a wireless wide area network (WWAN) have become popular. In this case, the radio waves output from the wireless communication module when performing wireless communication may be required to meet a specific SAR (Specific Absorption Rate) reference value, for example to meet requirements set by the local communication or broadcasting government agency.

### SUMMARY

According to one or more embodiments, an information processing apparatus includes: a wireless communication module that performs wireless communication; and a module control unit. The module control unit enables operation of the wireless communication module in response to receiving an enable request for the wireless communication module. The enable request is output to the module control unit when a power reduction function that limits output power of radio waves output by the wireless communication module is enabled. The module control unit disables the operation of the wireless communication module in response to receiving a disable request for the wireless communication module. The disable request is output to the module control unit when the power reduction function is disabled.

### BRIEF DESCRIPTION OF THE DRAWINGS

FIG. 1 is a diagram illustrating an example of the main hardware configuration of a laptop PC according to one or more embodiments.

FIG. 2 is a block diagram illustrating an example of the functional configuration of the laptop PC according to one or more embodiments.

FIG. 3 is a flowchart illustrating an example of BIOS processing in one or more embodiments.

FIG. 4 is a diagram illustrating an example of the operation of the laptop PC according to one or more embodiments.

FIG. 5 is a flowchart illustrating an example of processing of a DPR function in one or more embodiments.

### DETAILED DESCRIPTION

An information processing apparatus and a control method according to one embodiment of the present disclosure will be described below with reference to the accompanying drawings.

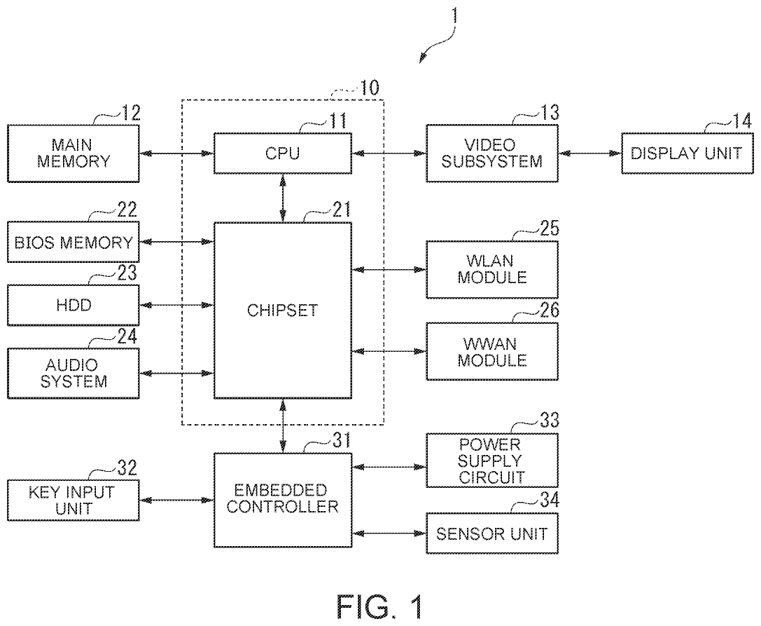

FIG. 1 is a diagram illustrating an example of the main hardware configuration of a laptop PC 1 according to one or more embodiments.

As illustrated in FIG. 1, the laptop PC 1 (laptop personal computer) includes a CPU 11, a main memory 12, a video subsystem 13, a display unit 14, a chipset 21, a BIOS memory 22, an HDD 23, an audio system 24, a WLAN module 25, a WWAN module 26, an embedded controller 31, a key input unit 32, a power supply circuit 33, and a sensor unit 34. Note that the laptop PC 1 will be described in one or more embodiments as an example of the information processing apparatus.

The CPU (Central Processing Unit) 11 executes various kinds of arithmetic processing by program control to control the entire laptop PC 1.

The main memory 12 is a writable memory used as reading areas of execution programs of the CPU 11 or working areas to which processing data of the execution programs are written. The main memory 12 is configured, for example, to include plural DRAM (Dynamic Random Access Memory) chips. The execution programs include an OS (Operating System), various drivers for hardware-operating peripheral devices, various services/utilities, application programs, and the like.

The video subsystem 13 is a subsystem for realizing functions related to image display, which includes a video controller. This video controller processes a drawing command from the CPU 11, writes processed drawing information into a video memory, and reads this drawing information from the video memory and outputs it to the main display unit 14 as drawing data (display data).

The display unit 14 is, for example, a liquid crystal display or an organic EL (Electro-Luminescence) display to display, as a main screen of the laptop PC 1, a display screen based on the drawing data (display data) output from the video subsystem 13.

The chipset 21 includes controllers, such as USB (Universal Serial Bus), serial ATA (AT Attachment), an SPI (Serial Peripheral Interface) bus, a PCI (Peripheral Component Interconnect) bus, a PCI-Express bus, and an LPC (Low Pin Count) bus, and plural devices are connected to the chipset 21. In FIG. 1, the BIOS memory 22, the HDD 23, the audio system 24, the WLAN module 25, the WWAN module 26, and the embedded controller 31 are connected to the chipset 21 as examples of the devices.

The BIOS (Basic Input Output System) memory 22 is configured, for example, by an electrically rewritable nonvolatile memory such as an EEPROM (Electrically Erasable Programmable Read Only Memory) or a flash ROM. The BIOS memory 22 stores a BIOS and system firmware for controlling the embedded controller 31 and the like.

The HDD (Hard Disk Drive) 23 (an example of a nonvolatile storage device) stores the OS, various drivers, various services/utilities, application programs, and various data.

The audio system 24 records, plays back, and outputs sound data.

The WLAN (Wireless Local Area Network) module 25 is connected to a network through a wireless LAN to perform data communication.

The WWAN (Wireless Wide Area Network) module 26 is connected to a network through a wireless WAN to perform data communication. The WWAN module 26 is an example of a wireless communication module, which includes an unillustrated antenna. The WWAN module 26 is, for example, a WWAN card attached to the laptop PC 1 as an optional part after the product of the laptop PC 1 is shipped. The WWAN module 26 is connected to the network using a mobile communication system, such as the third generation mobile communication system (3G), the fourth generation mobile communication system (4G), or the fifth generation mobile communication system (5G).

In one or more embodiments, it is assumed that the WWAN module 26 has obtained the technical standards certification from the FCC (Federal Communications Commission of the United States) and the like by using a DPR function (power reduction function) to limit the output power of radio waves output by the WWAN module 26. The details of the DPR function will be described later.

The embedded controller 31 (an example of an embedded control unit) is a one-chip microcomputer which monitors and controls various devices (peripheral devices, sensors, and the like) regardless of the system state of the laptop PC 1. Further, the embedded controller 31 has a power management function to control the power supply circuit 33. Note that the embedded controller 31 is composed of a CPU, a ROM, a RAM, and the like, which are not illustrated, and includes a multi-channel A/D input terminal, a D/A output terminal, a timer, and a digital input/output terminal. To the embedded controller 31, for example, the key input unit 32, the power supply circuit 33, the sensor unit 34, and the like are connected through these input/output terminals, and the embedded controller 31 controls the operation of these units.

The key input unit 32 is an input device such as a keyboard or a touch panel to accept key input from a user.

The power supply circuit 33 includes, for example, a DC/DC converter, a charge/discharge unit, a battery unit, an AC/DC adapter, and the like to convert DC voltage supplied from the AC/DC adapter or the battery unit into plural voltages required to operate the laptop PC 1. Further, the power supply circuit 33 supplies power to each unit of the laptop PC 1 under the control of the embedded controller 31.

The sensor unit 34 is, for example, an acceleration sensor, a human sensor, or the like. The sensor unit 34 can detect the presence of a human body, for example, proximate to the WWAN module 26 (particularly around the antenna).

In one or more embodiments, the CPU 11 and the chipset 21 described above correspond to a main control unit 10. The main control unit 10 executes processing based on an OS (for example, Windows (registered trademark)).

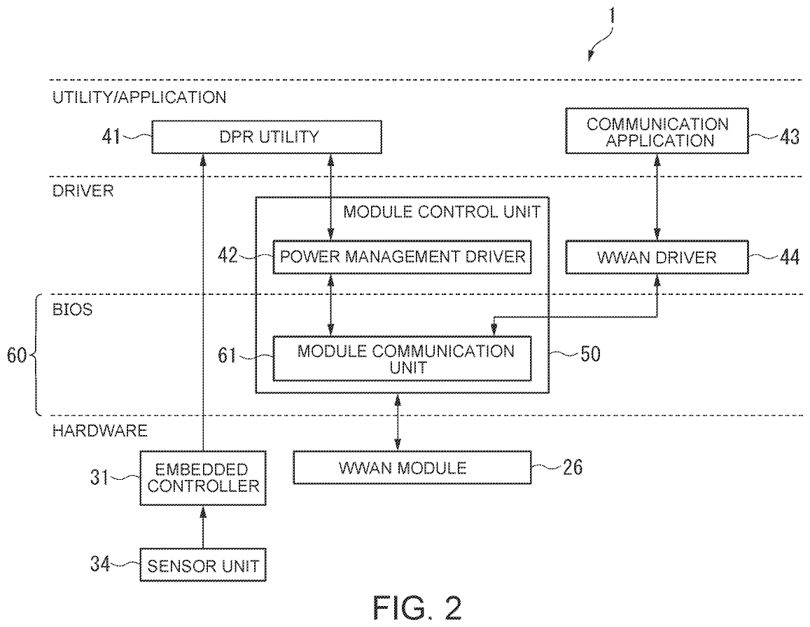

Referring next to FIG. 2, the functional configuration of the laptop PC 1 according to one or more embodiments will be described.

FIG. 2 is a block diagram illustrating an example of the functional configuration of the laptop PC 1 according to one or more embodiments.

As illustrated in FIG. 2, the laptop PC 1 according to one or more embodiments includes a DPR utility 41, a power management driver 42, a communication application 43, a WWAN driver 44, a module communication unit 61, the WWAN module 26, the embedded controller 31, and the sensor unit 34.

Only the main functional configuration related to one or more embodiments is illustrated as the configuration of the laptop PC 1 in FIG. 2.

The DPR utility 41, the power management driver 42, the communication application 43, and the WWAN driver 44 are functional units implemented by reading programs stored in the HDD 23 into the main memory 12 and causing the main control unit 10 to execute the programs. These functional units execute various processing based on the OS (Windows (registered trademark)).

Further, the module communication unit 61 is a functional unit as part of a BIOS 60, which is implemented by reading a program stored in the BIOS memory 22 into the main memory 12 and causing the main control unit 10 to execute the program.

In one or more embodiments, the power management driver 42 and the module communication unit 61 correspond to a module control unit 50.

Further, the WWAN module 26, the embedded controller 31, and the sensor unit 34 are hardware components described above with reference to FIG. 1.

The DPR utility 41 is a functional unit that realizes the DPR function. Here, the DPR function is a function to limit output power of radio waves output by the WWAN module 26 when a human body is detected proximate to the WWAN module 26 (particularly the antenna). The DPR utility 41 acquires detection information detected by the sensor unit 34 via the embedded controller 31, and based on the detection information, determines whether a human body is present around the WWAN module 26 or not. In other words, the DPR utility 41 detects, by the sensor unit 34, whether a human body is present around the WWAN module 26 or not.

When detecting a human body around the WWAN module 26, the DPR utility 41 reduces the output power of the WWAN module 26 via the power management driver 42 and the module communication unit 61. Note that, when detecting a human body around the WWAN module 26, the DPR utility 41 may also change the setting of the upper limit of the output power of the WWAN module 26 to a lower setting value.

Further, when the functional unit is started to enable the DPR function, the DPR utility 41 outputs an enable command (an example of an enable request) for enabling the WWAN module 26 to the power management driver 42 of the module control unit 50 to enable the WWAN module 26.

Further, when the operation of the functional unit is stopped to disable the DPR function, the DPR utility 41 outputs a disable command (an example of a disable request) for disabling the WWAN module 26 to the power management driver 42 of the module control unit 50 to disable the WWAN module 26.

Note that the DPR utility 41 has an execution authority (an example of a predetermined execution authority) such as an OS administrator privilege, and at least the enable command (Enable Command) is executable when the DPR utility 41 has the execution authority. For example, the administrator privilege here is an execution authority required to install the DPR utility 41.

When the DPR function is enabled, the module control unit 50 enables the operation of the WWAN module 26, while when the DPR function is disabled, the module control unit 50 disables the operation of the WWAN module 26. For example, the module control unit 50 enables the operation of the WWAN module 26 in response to the enable command of the WWAN module 26 output from the DPR utility 41 when the DPR function is enabled. The module control unit 50 transmits “Deassert W_DISABLE#” to enable the WWAN module 26 in response to the enable command.

Further, for example, the module control unit 50 disables the operation of the WWAN module 26 in response to the disable command of the WWAN module 26 output from the DPR utility 41 when the DPR function is disabled. The module control unit 50 transmits “Assert W_DISABLE#” to disable the WWAN module 26 in response to the disable command.

For example, when the output source (for example, the DPR utility 41 or the like) of the enable command has the execution authority (for example, administrator privilege) described above, the module control unit 50 executes processing for enabling the operation of the WWAN module 26 in response to the enable command. Further, for example, when the output source of the enable command does not have the execution authority described above, the module control unit 50 executes processing for disabling the operation of the WWAN module 26.

Further, the module control unit 50 disables the operation of the WWAN module 26 when the laptop PC 1 is booted. In other words, when the laptop PC 1 is booted, the module control unit 50 transmits “Assert W_DISABLE#” to the WWAN module 26. Note that the boot of the laptop PC 1 here includes the reboot of the laptop PC 1.

Further, the module control unit 50 includes the power management driver 42 and the module communication unit 61.

The power management driver 42 is a PM (Power Management) driver which manages the power control of the laptop PC 1. The power management driver 42 controls the output power of the WWAN module 26 through the module communication unit 61 in response to various requests from the DPR utility 41.

The module communication unit 61 is part of the BIOS 60, which interfaces with the WWAN module 26. In response to the enable command described above, the module communication unit 61 transmits “Deassert W_DISABLE#” to the WWAN module 26. Further, in response to the disable command described above, the module communication unit 61 transmits “Assert W_DISABLE#” to the WWAN module 26. Note that the module communication unit 61 executes processing of these commands when the output source of these commands has the execution authority (for example, administrator privilege) described above.

Further, when the laptop PC 1 is booted, the module communication unit 61 transmits, to the WWAN module 26, “Assert W_DISABLE#” to disable the operation of the WWAN module 26.

The communication application 43 is a functional unit which executes an application to perform communication using the WWAN module 26. For example, the communication application 43 corresponds to email software, browser software, any of various applications using network communication, or the like. When performing network communication, the communication application 43 performs communication with the WWAN module 26 through the WWAN driver 44 to perform network communication with the outside.

The WWAN driver 44 is a device driver which performs communication control of the WWAN module 26. The WWAN driver 44 performs communication with the WWAN module 26 via the module communication unit 61 to perform network communication with the outside. Note that the WWAN driver can generally control the WWAN module 26 to execute network communication with the outside regardless of the DPR function. However, in one or more embodiments, when the DPR function is disabled (when the WWAN module 26 is disabled), the module communication unit 61 does not accept control to the WWAN module 26. Therefore, the WWAN driver 44 can perform the communication control of the WWAN module 26 only when the DPR function is enabled.

Referring next to the accompanying drawings, the operation of the laptop PC 1 according to one or more embodiments will be described.

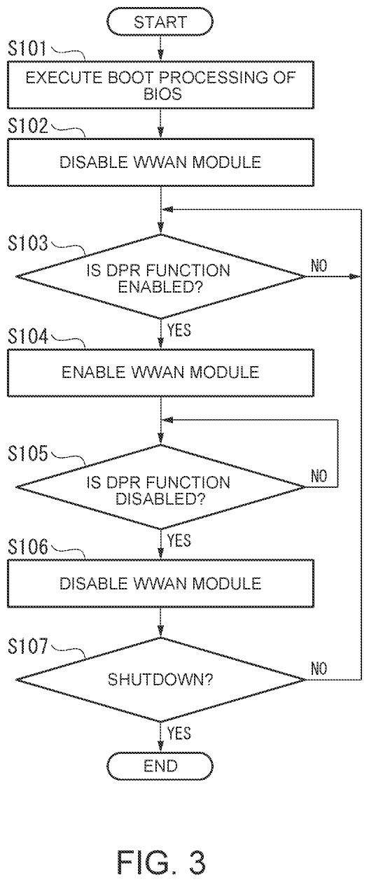

FIG. 3 is a flowchart illustrating an example of processing of the BIOS 60 in one or more embodiments.

As illustrated in FIG. 3, when the laptop PC 1 is booted, the BIOS 60 of the laptop PC 1 first executes initialization processing of the BIOS 60 (step S101). The BIOS 60 checks programs and data stored in the BIOS memory and performs initialization processing on various peripheral devices.

Next, the BIOS 60 disables the WWAN module 26 (step S102). The module communication unit 61 of the BIOS 60 transmits, to the WWAN module 26, “Assert W_DISABLE#” to disable the operation of the WWAN module 26. This reliably stops and disables the operation of the WWAN module 26.

Next, the module communication unit 61 determines whether the DPR function is enabled or not (step S103). The module communication unit 61 determines whether the DPR function is enabled or not, for example, according to whether the enable command of the WWAN module 26 is received from the DPR utility 41 via the power management driver 42 or not. When the DPR function is enabled (when the enable command is received from the DPR utility 41) (step S103: YES), the module communication unit 61 causes the processing to proceed to step S104. On the other hand, when the DPR function is not enabled (when the enable command is not received from the DPR utility 41) (step S103: NO), the module communication unit 61 returns the processing to step S103.

In step S104, the module communication unit 61 enables the WWAN module 26. For example, the module communication unit 61 transmits, to the WWAN module 26, “Deassert W_DISABLE#” to enable the operation of the WWAN module 26. Thus, the WWAN module 26 is enabled to start operating.

Next, the module communication unit 61 determines whether the DPR function is disabled or not (step S105). The module communication unit 61 determines whether the DPR function is disabled or not, for example, according to whether the disable command of the WWAN module 26 is received from the DPR utility 41 via the power management driver 42 or not. When the DPR function is disabled (when the disable command is received from the DPR utility 41) (step S105: YES), the module communication unit 61 causes the processing to proceed to step S106. On the other hand, when the DPR function is not disabled (when the disable command is not received from the DPR utility 41) (step S105: NO), the module communication unit 61 returns the processing to step S105.

In step S106, the module communication unit 61 disables the WWAN module 26. For example, the module communication unit 61 transmits, to the WWAN module 26, “Assert W_DISABLE#” to disable the operation of the WWAN module 26. Thus, the WWAN module 26 is disabled to stop operating.

Next, the BIOS 60 determines whether the laptop PC 1 is shut down or not (step S107). In other words, the BIOS 60 determines whether the laptop PC 1 stops operating or not. When the laptop PC 1 is shut down (step S107: YES), the BIOS 60 ends the processing. On the other hand, when the laptop PC 1 is not shut down (step S107: NO), the BIOS 60 returns the processing to step S103.

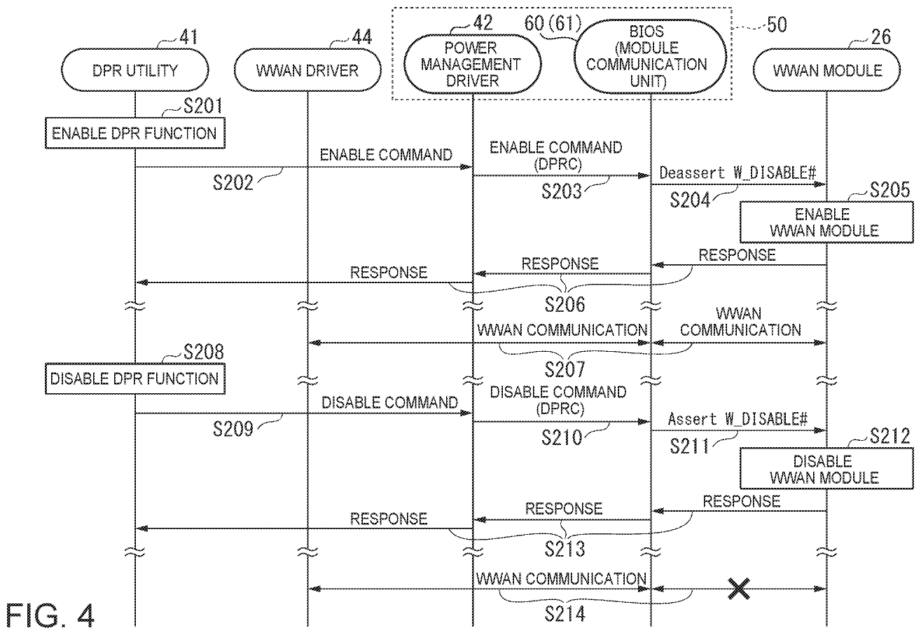

Referring next to FIG. 4, an example of the operation of the laptop PC 1 according to one or more embodiments will be described.

FIG. 4 is a diagram illustrating an example of the operation of the laptop PC 1 according to one or more embodiments. Here, an example of the operation of the module control unit 50 related to the DPR function will be described.

As illustrated in FIG. 4, when the DPR utility 41 is launched, the DPR utility 41 first enables the DPR function (step S201).

Next, the DPR utility 41 transmits the enable command (Enable Command) to the power management driver 42 of the module control unit 50 (step S202).

Next, in response to the enable command (Enable Command) from the DPR utility 41, the power management driver transmits the enable command (DPRC) to the module communication unit 61 of the BIOS 60 (step S203).

Next, in response to the enable command (DPRC) from the power management driver 42, the BIOS 60 (module communication unit 61) transmits “Deassert W_DISABLE#” to the WWAN module 26 (step S204).

Next, in response to “Deassert W_DISABLE#” from the BIOS 60 (module communication unit 61), the WWAN module 26 is enabled to start operating (step S205).

Next, the WWAN module 26 transmits a response (command response) to the DPR utility 41 via the BIOS 60 (module communication unit 61) and the power management driver 42 (step S206).

In this state, since the WWAN module 26 is enabled, the WWAN module 26 is available. Therefore, for example, in response to a communication request from the communication application 43, the WWAN driver 44 uses the WWAN module 26 to execute network communication through WWAN (step S207).

Next, when the DPR utility 41 is stopped, the DPR utility 41 first disables the DPR function (step S208).

Next, the DPR utility 41 transmits the disable command (Disable Command) to the power management driver 42 of the module control unit 50 (step S209).

Next, in response to the disable command (Disable Command) from the DPR utility 41, the power management driver transmits the disable command (DPRC) to the module communication unit 61 of the BIOS 60 (step S210).

Next, in response to the disable command (DPRC) from the power management driver 42, the BIOS 60 (module communication unit 61) transmits “Assert W_DISABLE#” to the WWAN module 26 (step S211).

Next, in response to “Assert W_DISABLE#” from the BIOS 60 (module communication unit 61), the WWAN module 26 is disabled to stop operating (step S212).

Next, the WWAN module 26 transmits a response (command response) to the DPR utility 41 via the BIOS 60 (module communication unit 61) and the power management driver 42 (step S213).

In this state, since the WWAN module 26 is disabled, the WWAN module 26 is unavailable. Therefore, the WWAN driver 44 cannot use the WWAN module 26 to execute WWAN network communication, for example, upon communication request from the communication application 43 (step S214). Here, the BIOS 60 (module communication unit 61) may also block the WWAN network communication.

In the example illustrated in FIG. 4 described above, the case where a program of the DPR utility 41 is installed on the laptop PC 1 and the laptop PC 1 includes the DPR utility 41 is described, but such a case that the laptop PC 1 does not include the DPR utility 41 may also be considered. When the laptop PC 1 does not include the DPR utility 41, since the WWAN module 26 remains disabled without being enabled, a step like step S214 described above is executed.

In other words, when the laptop PC 1 does not include the DPR utility 41, since the WWAN module 26 is in the disabled state, the WWAN module 26 is unavailable. Therefore, the WWAN driver 44 cannot use the WWAN module 26 to execute WWAN network communication, for example, upon communication request from the communication application 43.

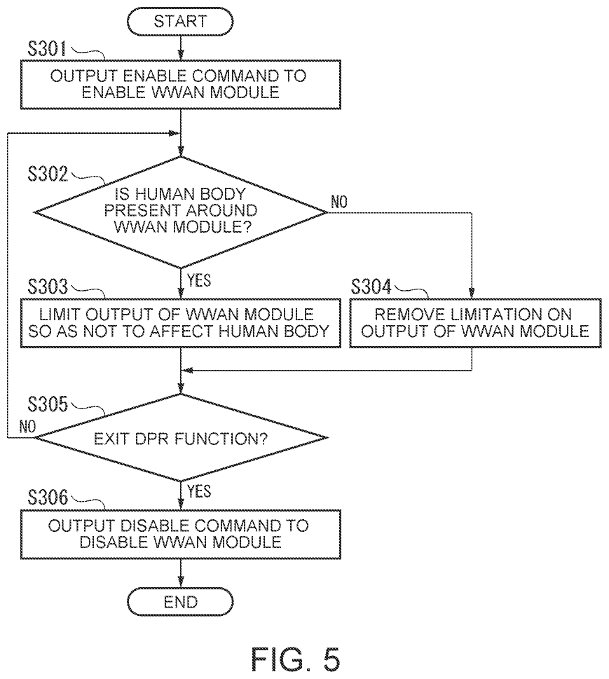

Referring next to FIG. 5, the operation of the DPR function in one or more embodiments will be described.

FIG. 5 is a flowchart illustrating an example of processing of the DPR function in one or more embodiments.

As illustrated in FIG. 5, when being booted, the DPR utility 41 of the laptop PC 1 first outputs the enable command to enable the WWAN module 26 (step S301). The DPR utility 41 enables the WWAN module 26 by the above-described processing from step S201 to step S205 in FIG. 4.

Next, the DPR utility 41 determines whether a human body is present around the WWAN module 26 or not (step S302). The DPR utility 41 acquires detection information of the sensor unit 34 through the embedded controller 31, and detects that a human body is present around the WWAN module 26 based on the detection information. When a human body is present around the WWAN module 26 (step S302: YES), the DPR utility 41 causes the processing to proceed to step S303. On the other hand, when a human body is not present around the WWAN module 26 (step S302: NO), the DPR utility 41 causes the processing to proceed to step S304.

In step S303, the DPR utility 41 limits the output of the WWAN module 26. For example, the DPR utility 41 reduces the output power of the WWAN module 26 via the power management driver 42 and the module communication unit 61. After step S303, the DPR utility 41 causes the processing to proceed to step S305.

Further, in step S304, the DPR utility 41 removes the limitation on the output of the WWAN module 26. For example, the DPR utility 41 increases the output power of the WWAN module 26 via the power management driver 42 and the module communication unit 61 to remove the limitation. After step S304, the DPR utility 41 causes the processing to proceed to step S305.

In step S305, the DPR utility 41 determines whether to exit the DPR function or not. When exiting the DPR function (step S305: YES), the DPR utility 41 causes the processing to proceed to step S306. On the other hand, when not exiting the DPR function (step S305: NO), the DPR utility 41 returns the processing to step S302.

In step S306, the DPR utility 41 outputs the disable command to disable the WWAN module 26. The DPR utility 41 disables the WWAN module 26 by the above-described processing from step S208 to step S213 in FIG. 4. After step S306, the DPR utility 41 ends the processing.

As described above, the laptop PC 1 (information processing apparatus) according to one or more embodiments includes the WWAN module 26 (wireless communication module) and the module control unit 50. The WWAN module 26 performs wireless communication. When a human body is detected around the WWAN module 26, the module control unit 50 enables the operation of the WWAN module 26 in a case where the DPR function (power reduction function) is enabled. Here, the DPR function is a function to limit the output power of radio waves output by the WWAN module 26. On the other hand, in a case where the DPR function is disabled, the module control unit 50 disables the operation of the WWAN module 26.

Thus, when the DPR function is disabled, the laptop PC 1 according to one or more embodiments disables the operation of the WWAN module 26. For example, when the WWAN module 26 (wireless communication module) is optionally retrofitted without incorporating the DPR function, the WWAN module 26 cannot be operated. Therefore, the WWAN module 26 can be operated reliably in a state where the DPR function is enabled.

Further, when the DPR function is stopped for some reason or when the DPR function is removed (uninstalled), the laptop PC 1 according to one or more embodiments cannot also operate the WWAN module 26. Thus, the WWAN module 26 can be disabled when the DPR function is not enabled.

Further, in one or more embodiments, the module control unit 50 disables the operation of the WWAN module 26 when the laptop PC 1 is booted.

Thus, the laptop PC 1 according to one or more embodiments can disable the operation of the WWAN module 26 more reliably when the DPR function is in the disabled state.

Further, in one or more embodiments, the module control unit 50 enables the operation of the WWAN module 26 in response to the enable command (enable request) of the WWAN module 26 output when the DPR function is enabled. Further, the module control unit 50 disables the operation of the WWAN module 26 in response to the disable command (disable request) of the WWAN module 26 output when the DPR function is disabled.

Thus, the laptop PC 1 according to one or more embodiments can operate the WWAN module 26 by simple processing as the command processing in a state where the DPR function is enabled.

Further, in one or more embodiments, the DPR function has a predetermined execution authority (for example, an administrator privilege or the like) that can execute specific processing based on the OS (for example, Windows (registered trademark)). When the output source of the enable command has the predetermined execution authority (for example, the administrator privilege or the like), the module control unit 50 enables the operation of the WWAN module 26 in response to the enable command. On the other hand, when the output source of the enable command does not have the predetermined execution authority (for example, the administrator privilege or the like), the module control unit 50 disables the operation of the WWAN module 26.

Thus, the laptop PC 1 according to one or more embodiments can use the WWAN module 26 only when having the predetermined execution authority (for example, the administrator privilege or the like), and unauthorized software such as malware cannot enable the WWAN module 26. Therefore, the laptop PC 1 according to one or more embodiments can further improve security to use the WWAN module 26 (wireless communication module) securely.

Further, in one or more embodiments, the wireless communication module described above is the WWAN module 26.

Thus, the laptop PC 1 according to one or more embodiments can perform WWAN network communication higher in output than that of wireless LAN more securely.

Further, in one or more embodiments, the WWAN module 26 is attached to the laptop PC 1 after the product of the laptop PC 1 is shipped. Since the laptop PC 1 according to one or more embodiments cannot use the WWAN module 26 in the state where the DPR function is disabled, the WWAN module 26 is not used in a state that does not meet the product standards certification from the FCC and the like even when the WWAN module 26 is attached to the laptop PC 1 after the product of the laptop PC 1 is shipped.

Further, a control method according to one or more embodiments is a control method for the laptop PC 1 (information processing apparatus) including the WWAN module 26 which performs wireless communication, the control method including an enabling step and a disabling step. In the enabling step, the module control unit 50 enables the operation of the WWAN module 26 in a case where the DPR function to limit the output power of radio waves output by the WWAN module 26 is enabled when a human body is detected around the WWAN module 26. In the disabling step, the module control unit 50 disables the operation of the WWAN module 26 in a case where the DPR function is disabled.

Thus, the control method according to one or more embodiments has the same effect as the laptop PC 1 according to one or more embodiments described above, and the wireless communication module can be made available in the state where the DPR function is enabled even when the WWAN module 26 (wireless communication module) is retrofitted.

The technical significant of one or more embodiments may be more clearly appreciated by comparison with a comparative reference apparatus. In particular, consider a comparative example information processing apparatus having a DPR (Dynamic Power Reduction) function to limit power used to output radio waves when a human body is proximate to a wireless communication module. In this case, if the comparative reference apparatus is manufactured without a built-in wireless communication module, the corresponding DPR function would be natively disabled or otherwise unavailable as well.

In the comparative example case, when a user attaches a separately obtained wireless communication module to an information processing apparatus that did not ship with a wireless communication module and thus also did not ship with a DPR function, the user is required to install or otherwise enable the DPR function as well.

In this regard, the information processing apparatus of one or more embodiments is capable of receiving a post-market (retrofitted) wireless communication module while ensuring that a DPR function is automatically and reliably enabled even when the wireless communication module is retrofitted.

Note that the present disclosure is not limited to the aforementioned embodiment, and changes can be made without departing from the scope of the present disclosure.

For example, in the aforementioned embodiment, the example in which the information processing apparatus is the laptop PC 1 is described, but the present disclosure is not limited to this example. For example, the information processing apparatus may also be any other type of information processing apparatus, such as a tablet terminal, a desktop PC, or a smartphone.

Further, in the aforementioned embodiment, the example in which the module control unit 50 determines whether the DPR function is enabled or not based on the command received from the DPR utility 41 is described, but the present disclosure is not limited to this example. The laptop PC 1 may also include a storage unit for storing state information indicative of the state of whether the DPR function is enabled or not so that the module control unit 50 refers to the state information stored in the storage unit to determine whether the DPR function is enabled or not.

Further, in the aforementioned embodiment, the example in which the module control unit 50 includes the power management driver 42 to receive the enable command and the disable command via the power management driver 42 is described, but the present disclosure is not limited to this example. The module control unit 50 may also not include the power management driver 42 so that the module communication unit 61 receives the enable command and the disable command directly.

Further, in the aforementioned embodiment, the example in which the wireless communication module is the WWAN module 26 is described, but the present disclosure is not limited to this example. The wireless communication module may also be any other wireless communication type of wireless communication module as long as the wireless communication type is required to use the DPR function.

Note that each of the components included in the laptop PC 1 described above has a computer system therein. Then, a program for implementing the function of each of the components included in the laptop PC 1 described above may be recorded on a computer-readable recording medium so that the program recorded on this recording medium is read into the computer system and executed to perform processing in each component included in the laptop PC 1 described above. Here, the fact that “the program recorded on the recording medium is read into the computer system and executed” includes installing the program on the computer system. It is assumed that the “computer system” here includes the OS and hardware such as peripheral devices and the like.

Further, the “computer system” may also include two or more computers connected through networks including the Internet, WAN, LAN, and a communication line such as a dedicated line. Further, the “computer-readable recording medium” means a storage medium such as a flexible disk, a magneto-optical disk, a ROM, a portable medium like a CD-ROM, or a hard disk incorporated in the computer system. Thus, the recording medium with the program stored thereon may be a non-transitory recording medium such as the CD-ROM.

Further, a recording medium internally or externally provided to be accessible from a delivery server for delivering the program is included as the recording medium. Note that the program may be divided into plural pieces, downloaded at different timings, respectively, and then united in each component included in the laptop PC 1, or delivery servers for delivering respective divided pieces of the program may be different from one another. Further, the “computer-readable recording medium” includes a medium on which the program is held for a given length of time, such as a volatile memory (RAM) inside a computer system as a server or a client when the program is transmitted through a network. The above-mentioned program may also be to implement some of the functions described above. Further, the program may be a so-called differential file (differential program) capable of implementing the above-described functions in combination with a program(s) already recorded in the computer system.

Further, some or all of the above-described functions may be realized as an integrated circuit such as LSI (Large Scale Integration). Each of the above-described functions may be implemented by a processor individually, or some or all of the functions may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An information processing apparatus comprising:
a wireless communication module that performs wireless communication; and
a module control unit that:
enables operation of the wireless communication module in response to receiving an enable request for the wireless communication module, wherein the enable request is output to the module control unit when a power reduction function that limits output power of radio waves output by the wireless communication module is enabled; and
disables the operation of the wireless communication module in response to receiving a disable request for the wireless communication module, wherein the disable request is output to the module control unit when the power reduction function is disabled.

2. The information processing apparatus according to claim 1, wherein the module control unit disables the operation of the wireless communication module when the information processing apparatus is booted up.

3. The information processing apparatus according to claim 1, wherein
the power reduction function has a predetermined execution authority that can execute specific processing based on an Operating System (OS), and
the module control unit further:
enables, when an output source of the enable request has the predetermined execution authority, the operation of the wireless communication module in response to the enable request; and
disables, when the output source of the enable request does not have the predetermined execution authority, the operation of the wireless communication module.

4. The information processing apparatus according claim 1, wherein the wireless communication module is a Wireless Wide Area Network (WWAN) module.

5. The information processing apparatus according to claim 1, wherein the wireless communication module is attached to the information processing apparatus after the information processing apparatus is shipped.

6. A control method for an information processing apparatus including a wireless communication module which performs wireless communication, the control method comprising:
enabling, with a module control unit, operation of the wireless communication module in response to receiving an enable request for the wireless communication module, wherein the enable request is output to the module control unit when a power reduction function that limits output power of radio waves output by the wireless communication module is enabled; and
disabling, with the module control unit, the operation of the wireless communication module in response to receiving a disable request for the wireless communication module, wherein the disable request is output to the module control unit when the power reduction function is disabled.

7. A mobile computer, comprising:
a wireless transceiver that performs wireless communication;
a memory having stored thereon instructions; and
a processor coupled to the wireless transceiver and that executes the instructions stored on the memory to:
enable operation of the wireless transceiver in response to receiving an enable request for the wireless transceiver, wherein the enable request is output to the processor when a power reduction function that limits output power of radio waves output by the wireless transceiver is enabled; and
disable the operation of the wireless transceiver in response to receiving a disable request for the wireless transceiver, wherein the disable request is output to the processor when the power reduction function is disabled.
